(19) United States
(12) Patent Application Publication
(10) Pub. No.: US 2009/0268704 A1
(43) Pub. Date: Oct. 29, 2009

(54) MOBILE COMMUNICATIONS SYSTEM FOR DYNAMICALLY CONTROLLING DATA RATE CONTROL LENGTH

(75) Inventor: Myong-Ju KIM, Seoul (KR)

Correspondence Address: H.C. PARK & ASSOCIATES, PLC, 8500 LEESBURG PIKE, SUITE 7500, VIENNA, VA, 22182, US

(73) Assignee: Pantech&Curitel Communications, Inc., Seoul (KR)

(21) Appl. No.: 12/388,940

(22) Filed: Feb. 19, 2009

(30) Foreign Application Priority Data
Apr. 29, 2008 (KR) 10-2008-0039884

(51) Int. Cl. H04B 7/216

(52) U.S. Cl. 370/342

(57) ABSTRACT

A mobile communications system includes a base station that performs packet data communications with a terminal. The base station includes a communication unit that receives a data rate control (DRC) value and a message from the terminal, the message including pilot channel information detected from a pilot channel signal sent to the terminal from the base station; a packet data generating unit that generates packet data according to the DRC value; and a control unit determines a number of active sets based on the pilot channel information, and dynamically controls a DRC length based on the determined number of active sets. Also, the control unit controls the communication unit to transmit the dynamically controlled DRC length information to the terminal. Accordingly, the DRC length is dynamically controlled to be more compatible with a wireless environment.

### CROSS REFERENCE TO RELATED APPLICATION

This application claims priority from and the benefit of Korean Patent Application No. 10-2008-0039884, filed on Apr. 29, 2008, which is hereby incorporated by reference for all purposes as if fully set forth herein.

### BACKGROUND

1. Field of the Invention

The present invention relates to a mobile communications system, and more particularly, to a mobile communications system for packet data communications that can control data rate control length.

2. Discussion of the Background

Along with the development of mobile communications technology, additional research on high-speed data transmission has been conducted. The CDMA (code division multiple access) 2000 1× evolution data only (EV-DO) system has a channel configuration for such high-speed data transmission. The CDMA 2000 1×EV-DO system is based on standards proposed by 3GPP2 (3 generation partnership project 2) for improving data communications in the IS-2000 system.

In CDMA 2000 1×EV-DO system, data communications can occur in two directions: forward and reverse. In forward data communications, data is transmitted from a base station to a terminal, and in reverse data communications, data is transmitted from a terminal to a base station. Each channel for forward data communications and reverse data communications includes sub-channels that have different purposes. Through the channels and sub-channels, various items of information are transmitted between the terminal and the base station. Thus, research has been carried out to improve the efficiency of data communications while reducing data processing load between a terminal and a base station in a mobile communications system.

### SUMMARY OF THE INVENTION

This invention provides a mobile communications system that can dynamically control a data rate control (DRC) length to be more compatible to a wireless communications environment.

Additional features of the invention will be set forth in the description which follows, and in part will be apparent from the description, or may be learned by practice of the invention.

The present invention discloses a base station including a communication unit a communication unit to receive a data rate control (DRC) value and a message from a terminal, the message including pilot channel information that is detected from one or more pilot channels corresponding to pilot signals received by the terminal, a packet data generating unit to generate packet data according to the DRC value, and a control unit to receive the message including the pilot channel information, to determine a number of active sets based on the pilot channel information included in the message, and to dynamically control a DRC length based on the determined number of active sets. Further, the control unit controls the communication unit to transmit the dynamically controlled DRC length information to the terminal.

The present invention also discloses a method for controlling a DRC length in a base station that performs packet data communications with a terminal. The method includes receiving a message from the terminal, the message including pilot channel information detected from one or more pilot channels corresponding to pilot signals received by the terminal, determining a number of active sets based on the pilot channel information, and dynamically determining the DRC length based on the determined number of active sets and transmitting the DRC length to the terminal.

The present invention also discloses a terminal including a control unit to detect one or more pilot channels corresponding to pilot signals received by the terminal, to determine a data rate control (DRC) value of the one or more pilot channels, and to generate a message including pilot channel information, a communication unit to transmit the determined DRC value and the message including the pilot channel information to a base station, and to receive packet data and a DRC length from the base station, and a data processing unit to process the packet data. Further, the control unit determines the DRC value for every DRC length that is dynamically controlled based on a number of active sets determined by the base station using the pilot channel information, and controls the communication unit to transmit the determined DRC value to the base station.

The present invention also discloses a method for transmitting a DRC value from a terminal to a base station that performs packet data communications with the terminal. The method includes detecting one or more pilot channels from pilot signals received by the terminal, and generating a message including pilot channel information, transmitting the message including the pilot channel information to the base station, receiving a DRC length that is dynamically controlled based on a number of active sets determined by the base station using the pilot channel information, and determining a DRC value for every DRC length that is dynamically controlled, and transmitting the determined DRC value to the base station.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a conceptual view of a CDMA 2000 1×EV-DO system.

FIG. 2 is a table showing DRC values informed by a terminal and a transmission rate and the number of transmission slots corresponding to each DRC value.

FIG. 3 is a table showing DRC lengths with respect to field values transmitted from a base station to a terminal.

FIGS. 4A, 4B, and 4C are diagrams illustrating forward traffic channels according to a DRC length.

FIG. 5 is a block diagram showing structures of a terminal and a base station according to an exemplary embodiment.

FIG. 6 is a flow chart illustrating a method of controlling a DRC length according to an exemplary embodiment.

FIG. 7 shows the structure of the route update signaling message in accordance with an exemplary embodiment.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

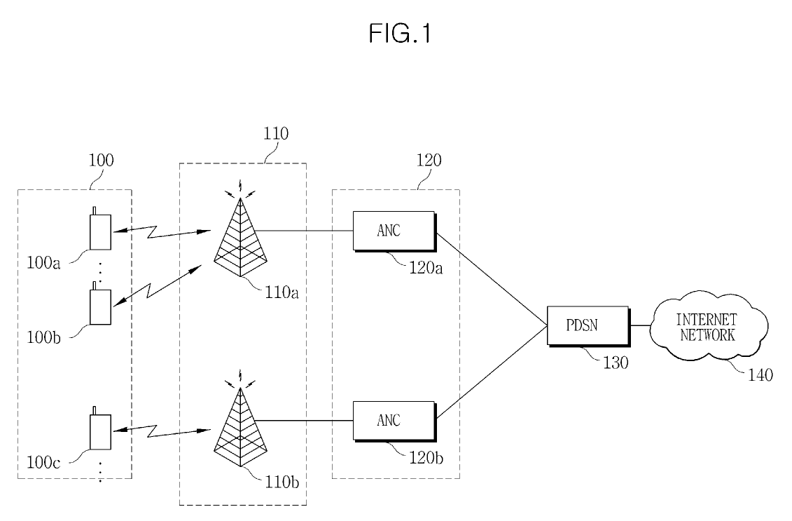

FIG. 1 is a conceptual view of a CDMA 2000 1×EV-DO system. Referring to FIG. 1, the mobile communications system includes mobile terminals 100A, 100B, and 100C, first and second base stations 110A and 110B, each of which has an access network transceiver system, and first and second access network controllers (ANC) 120A and 120B.

FIG. 1 shows that the mobile terminals 100A and 100B are communicating with the first base station 110A, and mobile terminal 100C is communicating with the second base station 110B. The first base station 110A is connected with the first access network controller 120A, and the second base station 110B is connected with the second access network controller 120B. Although FIG. 1 shows that each access network controller is connected to only a single base station, each access network controller may be connected to two or more base stations.

Each access network controller 120a and 120b is connected to a packet data service node (PDSN) 130, which is connected to the Internet network 140. Each mobile terminal 100A, 100B, and 100C receives one or more pilot signals from the first and second base stations 110A and 110B over a pilot channel established between each mobile terminal 100A, 100B, and 100C and each base station 110A and 110B. Each mobile terminal 100A, 100B, and 100C connects to a single base station 110A or 110B that has sent a signal having the strongest magnitude.

Hereinafter, the exemplary embodiments will be described for a mobile terminal 100, which may be any one of mobile terminals 100A, 100B, and 100C, and a base station 110, which may be any one of the base stations 110A and 110B.

According to DRC of a forward channel, the mobile terminal 100 measures the strength of received pilot signals sent from the base station 110, and based on the measured strength of the received pilot signals determines a forward data transmission rate according to a predetermined value.

The mobile terminal 100 transmits a DRC value corresponding to the determined forward data transmission rate to the base station 110 over a data transmission rate control channel. The base station 110 modulates data according to the received DRC value to generate packet data, and transmits the packet data to the mobile terminal 100.

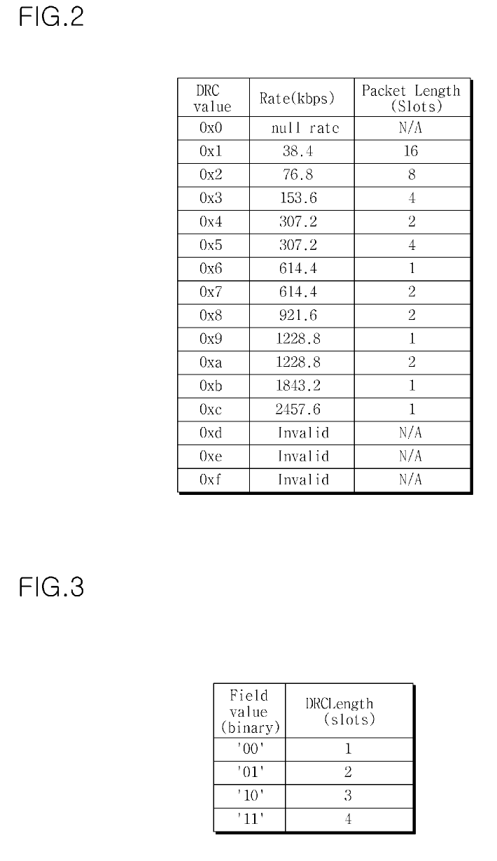

FIG. 2 is a table showing DRC values informed by the mobile terminal 100 and a transmission rate and the number of transmission slots corresponding to each DRC value.

More specifically, FIG. 2 is a table showing a relation between DRC values sent from the mobile terminal 100 to the base station 110, and the data transmission rate at which the base station 110 transmits data back to the mobile terminal 100, and also the number of slots of the data transmission. The mobile terminal 100 informs the base station 110 of the DRC value. The base station 110 then transmits data back to the mobile terminal 100 in a predetermined number of slots and at a transmission rate corresponding to the informed DRC value. The mobile terminal 100 that has informed the DRC value attempts to receive a forward data channel in a way corresponding to the DRC value.

For example, if the mobile terminal 100 sends the base station 110 a DRC value of 0×1, the base station 110 processes data at 38.4 kbps and transmits the processed data to the terminal 100 for 16 slots. At this time, the mobile terminal 100 repeatedly transmits a single piece of DRC information of a forward channel to the base station 110 for a predetermined unit of slots.

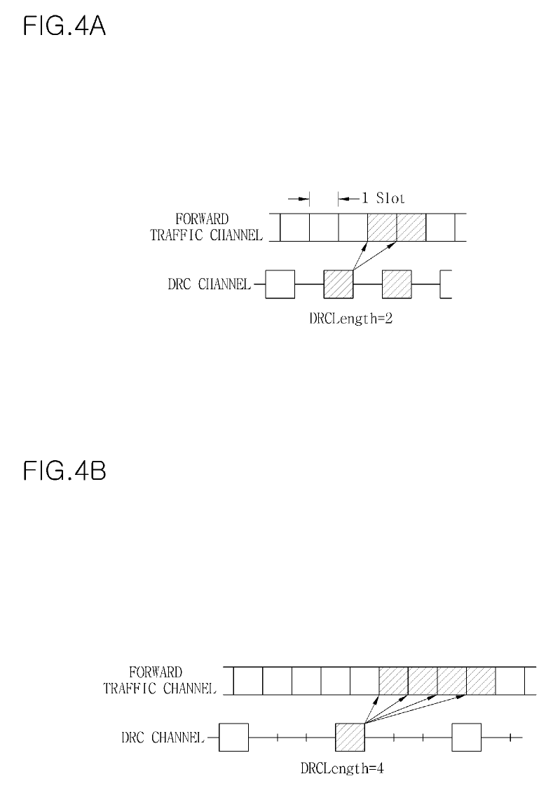

FIG. 3 is a table showing DRC lengths with respect to field values transmitted from the base station 110 to the mobile terminal 100.

Referring to FIG. 3, if a field value is ‘00’, a DRC length is ‘1’, and the mobile terminal 100 transmits the DRC value to the base station 110 every one slot. If the field value is ‘01’, the DRC length is 2 and the mobile terminal 100 transmits the DRC value to the base station 110 every two slots. If the field value is ‘10’, the DRC length is 3 and the mobile terminal 100 transmits the DRC value to the base station 110 every three slots. If the field value is ‘11’, the DRC length is 4 and the mobile terminal 100 transmits the DRC value to the base station 110 every four slots.

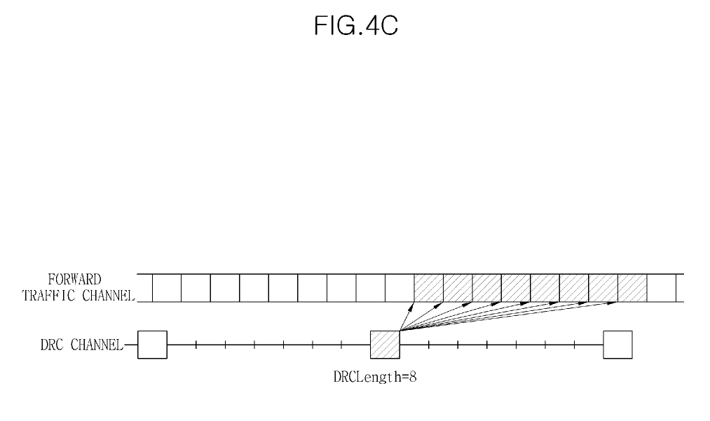

FIGS. 4A, 4B, and 4C are diagrams illustrating forward traffic channels according to a DRC length.

In FIG. 4A, if the DRC length is 2, it implies that the base station 110 transmits packet data to the mobile terminal 100 for two slots at a constant DRC transmission speed. FIG. 4B shows the base station 110 transmits packet data to the mobile terminal 100 for four slots at a constant DRC transmission speed if the DRC length is four. In a similar manner, FIG. 4C shows the base station 110 transmits packet data to the mobile terminal 100 for eight slots at a constant DRC transmission speed if the DRC length is eight.

If the base station 110 conventionally fixes the DRC length, it may increase data processing load for both the base station 110 and the mobile terminal 100. This is because the mobile terminal 100 may move through different environments, such as a pilot concentrated region in the urban or downtown area, where wireless conditions may change more rapidly, or the countryside, where wireless conditions may change with less frequency.

In the pilot concentrated region in a downtown or urban area, where wireless conditions may change more rapidly over a short distance, it is appropriate to have a short DRC length in order to more frequently request a DRC suitable for the wireless environment in which the various mobile terminals 100 communicating with the base station 110 are located. Meanwhile, in a rural area, the density of pilot is relatively small, so the DRC length may be set longer than the DRC length for the urban or downtown area.

For example, if the DRC length is set to one slot in the rural area, a mobile terminal 100 transmits a DRC value to the base station 110 at every one slot, and consequently, the data processing load increases on the terminal side. In addition, in this case, the base station 110 modulates data in response to the DRC value transmitted from the mobile terminal 100 at every slot and transmits the modulated data to the mobile terminal 100. Hence, the data processing load increases on the base station side as well. That is, since the wireless environment is not rapidly changing in the rural area, the long DRC length does not affect the communication, but the data processing load may burden both the mobile terminal 100 and the base station 110. On the contrary, if the DRC length is fixed to be long in the downtown or urban area, it may be difficult to properly perform data communications in a manner suitable for the rapidly changing wireless environment.

To improve the above-mentioned disadvantages of a fixed DRC length, a mobile communications system may dynamically control a DRC length according to a wireless environment.

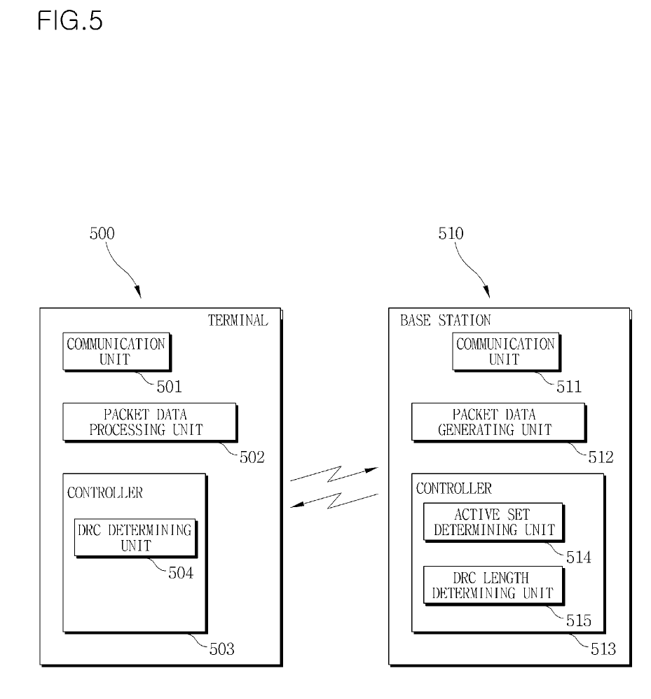

FIG. 5 is a block diagram showing structures of a terminal 500 and a base station 510 according to an exemplary embodiment. The terminal 500 and the base station 510 perform packet data communications therebetween.

The terminal 500 includes a communication unit 501, a packet data processing unit 502, and a controller 503. The terminal may be a hybrid mobile communication terminal that is capable of performing both voice and data communications. Hence, the terminal 500 may further include any other general elements such as a display unit, an audio output unit, and a user interface unit, besides the units illustrated in FIG. 5.

The communication unit 501 transmits and receives signals for performing packet data communications with the base station 510. The packet data processing unit 502 processes packet data transmitted from the communication unit 501, and provides the processed packet data to a user through an output unit (not shown). The controller 503 controls transmission/receipt of data between the elements of the terminals 500 to control the overall operation of the terminal 500.

The controller 503 detects a pilot channel that is received by the communication unit 501 and is sent from at least one base station, and determines a DRC value of each pilot channel. The DRC value is determined according to a pilot signal strength from a base station that sends the strongest pilot signal. Here, the base station that sends the strongest pilot signal is denoted as the base station 510. The controller 503 may include a DRC determining unit 504 that detects a pilot channel and determines a DRC value.

In addition, the controller 503 generates a message including pilot channel information. Then, the communication unit 501 sends the message including the pilot channel information and the determined DRC value to the base station 510. The message including the pilot channel information and the DRC value do not have to be transmitted to the base station 510 simultaneously, but can be transmitted individually to the base station 510.

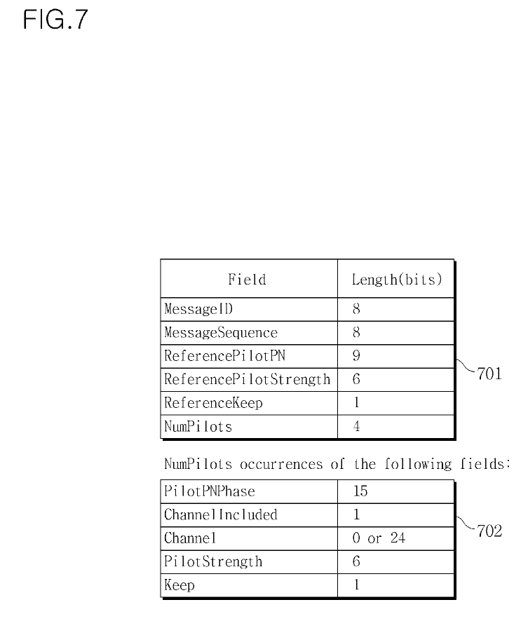

The pilot channel information includes information indicating the pilot signal strength of each pilot channel that is detected by the terminal 500. The message including the pilot channel information may be a route update signaling message to be used during active set update. FIG. 7 shows the structure of the route update signaling message in accordance with an exemplary embodiment. Also, FIG. 7 shows a table 701 of information to be included in the route update signaling message that conveys the pilot channel information according to the exemplary embodiment.

Referring to FIG. 7, a NumPilot value in the table 701 includes information of the number of pilot channels received from the detected base stations. Specification of the pilot channel may be configured as shown in a table 702. For example, if the route update signaling message indicates the number of the pilot channels is four, the route update signaling message may include the table 702 that shows the specification of the four pilot channels. In a PilotStrength field in the table 702, information of pilot signal strength of a corresponding base station is included. The pilot channel information is used for the base station 510 to determine the number of active sets.

Referring to FIG. 5 again, the communication unit 501 receives the packet data modulated according to the DRC value transmitted from the base station 510, and the packet data processing unit 502 processes the received packet data. Additionally, the communication unit 501 receives DRC length information. The DRC length information is dynamically controlled based on the number of active sets that has been determined from the pilot channel information by the base station 510. Then, the controller 503 controls the communication unit 501 to determine the DRC value for every DRC length and transmit the determined DRC value to the base station 510.

Hereinafter, the structure of the base station 510 will now be described.

According to an exemplary embodiment, the base station 510 includes a communication unit 511, a packet data generating unit 512, and a controller 513. The communication unit 511 transmits and receives signals for performing packet data communications with the terminal 500. The packet data generating unit 512 generates packet data by modulating data according to the DRC value that is sent by the terminal 500. The controller 513 controls the data transmission/receipt between the elements of the base station 510 to control the overall operation of the base station 510.

If the communication unit 511 receives a message including pilot channel information from the terminal 500, the controller 513 determines the number of active sets based on the pilot channel information included in the message. The pilot channel information is detected from the signal received from the base station 510 by the terminal 500.

Furthermore, the controller 513 dynamically controls the DRC length based on the determined number of active sets. The controller 513 controls the communication unit 511 to generate a message that includes dynamically controlled DRC length information and to transmit the generated message to the terminal 500.

The controller 513 may include an active set determining unit 514, a DRC length determining unit 515, or both. The active set determining unit 514 determines the number of active sets, and the DRC length determining unit 515 dynamically controls the DRC length.

The active set determining unit 514 extracts information of strength of at least one pilot signal from the message that is transferred from the terminal 500 and that includes pilot channel information. Then, the active set determining unit 514 may determine the number of active sets by the number of pilot channels having a signal strength that exceeds a predetermined strength threshold for a received pilot signal. Then, the DRC length determining unit 515 may dynamically determine the DRC length in inverse proportion to the number of active set. As shown in FIG. 3, the DRC length can have four different length values, and thus, can determine one of the four lengths.

For example, if there are a greater number of active sets, the DRC length determining unit 515 may conclude the wireless environment is pilot-concentrated and shorten the DRC length such that data communications suitable to the rapidly changing wireless environment can be established. On the other hand, if there are a few active sets, the DRC length determining unit 515 may increase the DRC length under the presumption that the current wireless environment is not pilot-concentrated.

Hence, according to the exemplary embodiment, the DRC length determining unit 515 maintains the original DRC length if the number of active sets is the same as the threshold, shortens the DRC length if the number of active sets is greater than the threshold, or increases the DRC length if the number of active sets is smaller than the threshold. Here, the threshold may be a fixed value, or may be a predetermined range of values.

For example, the original DRC length may be 2 slots and the range of the threshold may be from 2 to 3. In this case, the DRC length determining unit 515 may maintain the original DRC length of 2 slots if the number of active sets determined by the active set determining unit 514 is 2. If the determined number of active set is four, the DRC length determining unit 515 may reduce the DRC length to one slot. Additionally, if the number of active sets is one, the DRC length determining unit 515 may increase the DRC length to four slots. Besides, the DRC length determining unit 515 may lower the original DRC length to two levels to one slot if the original DRC length is four slots and the determined number of active sets is greater than a predetermined value, for example, greater than 8. In other words, various embodiments can be employed to control the DRC length.

Although the above-described structures of the terminal 500 and the base station 510 may be implemented in the CDMA 2000 1×EV-DO mobile communications system, these structures may be employed in other mobile communications systems having different configurations.

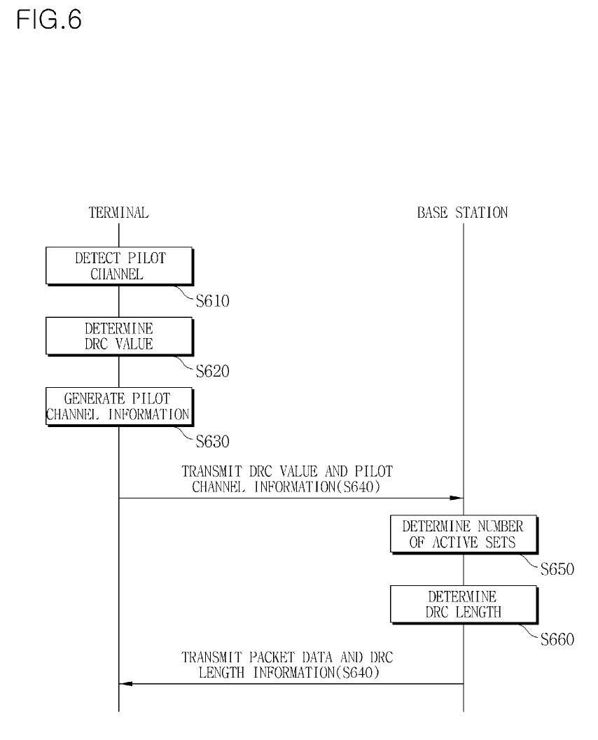

FIG. 6 is a flow chart illustrating a method of controlling a DRC length according to an exemplary embodiment. Referring to FIG. 6 in conjunction with FIG. 5, the terminal 500 detects a pilot channel from signals received from at least one base station (Operation S610). The terminal 500 determines a DRC value based on a pilot channel of the base station 510 that sends the strongest pilot signal (Operation S620).

The terminal 500 generates a message including information on at least one pilot channel (Operation S630), and sends the base station 510 the determined DRC value and the message including the pilot channel information (Operation S640). As described above, the message including the pilot channel information and the DRC value may be transmitted to the base station 510 at different time periods. Also, the pilot channel information may inform the base station 510 of the number of pilot channels detected by the mobile terminal 500 that have a pilot signal strength that exceeds a predetermined signal strength threshold for a received pilot signal. This number may correspond to a number of active sets.

The base station 510 determines the number of active sets based on the pilot channel information included in the message generated by the terminal 500 (Operation S650). The base station 510 dynamically determines a DRC length based on the determined number of active sets (Operation S660). At this time, the base station 510 may dynamically determine the DRC length in inverse proportion to the number of active sets.

Once the DRC length is determined, the base station 510 transmits DRC length information to the terminal 500 (Operation S670). Then, the base station 510 may transmit packet data, which has been modulated according to the received DRC value, along with the information.

If the terminal 500 receives the DRC length from the base station 510, which has determined the DRC length based on the number of active sets determined from the pilot channel information, (Operation S660), operation S620 may be performed repeatedly to determine a DRC value at every dynamically controlled DRC length, and the terminal 500 transmits the determined DRC value to the base station 510.

According to the exemplary embodiments, a DRC length is determined based on reliable information, so that base station resources are better conserved by avoiding a data process for setting the DRC length to be ineffectively short. In addition, according to the exemplary embodiments, a terminal may receive data according to a DRC value based on the DRC length that is variably allocated to the terminal in response to changes in a mobility environment, and thus data receipt can be carried out more efficiently.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A base station, comprising:
a communication unit to receive a data rate control (DRC) value and a message from a terminal, the message including pilot channel information that is detected from one or more pilot channels corresponding to pilot signals received by the terminal;
a packet data generating unit to generate packet data according to the DRC value; and
a control unit to receive the message including the pilot channel information, to determine a number of active sets based on the pilot channel information included in the message, and to dynamically control a DRC length based on the determined number of active sets,
wherein the control unit controls the communication unit to transmit the dynamically controlled DRC length information to the terminal.

2. The base station of claim 1, wherein the control unit dynamically determines the DRC length in inverse proportion to the determined number of active sets.

3. The base station of claim 2, wherein the control unit maintains a DRC length if the determined number of active sets is the same as a threshold, reduces the DRC length if the determined number of active sets is greater than the threshold, and increases the DRC length if the determined number of active sets is smaller than the threshold.

4. The base station of claim 1, wherein the pilot channel information includes information on a pilot signal strength of each pilot channel detected by the terminal.

5. The base station of claim 1, where the determined number of active sets corresponds to a number of pilot signals received by the terminal that have a pilot signal strength greater than a signal strength threshold.

6. A method for controlling a data rate control (DRC) length in a base station that performs packet data communications with a terminal, the method comprising:
receiving a message from the terminal, the message including pilot channel information detected from one or more pilot channels corresponding to pilot signals received by the terminal,
determining a number of active sets based on the pilot channel information; and
dynamically determining the DRC length based on the determined number of active sets and transmitting the DRC length to the terminal.

7. The method of claim 6, wherein dynamically determining the DRC length comprises controlling the DRC length in inverse proportion to the determined number of active sets.

8. The method of claim 7, wherein dynamically determining the DRC length comprises maintaining an original DRC length if the determined number of active sets equals a threshold, reducing the DRC length if the determined number of active sets is greater than the threshold, and increasing the DRC length if the determined number of active sets is smaller than the threshold.

9. The method of claim 6, wherein the pilot channel information includes information on a pilot signal strength of each pilot channel detected by the terminal.

10. The method of claim 6, where the determined number of active sets corresponds to a number of pilot signals received by the terminal that have a pilot signal strength greater than a signal strength threshold.

11. A terminal, comprising:
a control unit to detect one or more pilot channels corresponding to pilot signals received by the terminal, to determine a data rate control (DRC) value of the one or more pilot channels, and to generate a message including pilot channel information;
a communication unit to transmit the determined DRC value and the message including the pilot channel information to a base station, and to receive packet data and a DRC length from the base station; and
a data processing unit to process the packet data,
wherein the control unit determines the DRC value for every DRC length that is dynamically controlled based on a number of active sets determined by the base station using the pilot channel information, and controls the communication unit to transmit the determined DRC value to the base station.

12. The terminal of claim 11, wherein the pilot channel information includes information on a pilot signal strength of each pilot channel detected by the terminal.

13. The terminal of claim 11, wherein the message including the pilot channel information is a route update signaling message.

14. The terminal of claim 11, where the number of active sets corresponds to a number of pilot signals received by the terminal that have a pilot signal strength greater than a signal strength threshold.

15. A method for transmitting a data rate control (DRC) value from a terminal to a base station that performs packet data communications with the terminal, the method comprising:
detecting one or more pilot channels from pilot signals received by the terminal, and generating a message including pilot channel information;
transmitting the message including the pilot channel information to the base station;
receiving a DRC length that is dynamically controlled based on a number of active sets determined by the base station using the pilot channel information; and
determining a DRC value for every DRC length that is dynamically controlled, and transmitting the determined DRC value to the base station.

16. The method of claim 15, wherein the pilot channel information includes information on a pilot signal strength of each pilot channel detected by the terminal.

17. The method of claim 15, wherein the message including the pilot channel information is a route update signaling message.

18. The method of claim 15, where the number of active sets corresponds to a number of pilot signals received by the terminal that have a pilot signal strength greater than a signal strength threshold.
